(19) United States
(12) Patent Application Publication
(10) Pub. No.: US 2015/0372264 A1
(43) Pub. Date: Dec. 24, 2015

(54) Through Connecting Piece, Power Battery And Cap Assembly Thereof

(71) Applicant: Ningde Amperex Technology Limited, Ningde (CN)

(72) Inventors: Zhijun GUO, Ningde (CN); Pinghua DENG, Ningde (CN); Peng WANG, Ningde (CN)

(21) Appl. No.: 14/574,244

(22) Filed: Dec. 17, 2014

(30) Foreign Application Priority Data
Jun. 23, 2014 (CN) 201410285577.1

(51) Int. Cl. H01M 2/04; H01M 2/34; H01M 2/22; H02G 3/22; H01M 10/0525

(52) U.S. Cl. CPC H01M 2/0473; H02G 3/22; H01M 2/0482; H01M 10/0525; H01M 2/22; H01M 2/345; H01M 2/347

(57) ABSTRACT

The present disclosure provides a through connecting piece, a power battery and a cap assembly thereof. The through connecting piece comprises: a base having at least an opening; a conductor, the number of the conductor is the same as the number of the opening, the each conductor is provided through the corresponding one opening and a part of the each conductor received in the corresponding one opening has a shape of a racetrack or a rectangle with rounded corners in a top view; and a heat-resistant insulative material, the number of the heat-resistant insulative material is the same as the number of the opening, the each heat-resistant insulative material is filled in the opening between the corresponding one base and the corresponding one conductor. The cap assembly of power battery comprises the above through connecting piece. The power battery comprises the above cap assembly of the power battery.

### CROSS-REFERENCE TO RELATED APPLICATIONS

The present application claims priority to Chinese patent application No. 201410285577.1 filed on Jun. 23, 2014, which is incorporated herein by reference in its entirety.

### TECHNICAL FIELD OF THE PRESENT DISCLOSURE

The present disclosure relates to the field of energy storage devices, and particularly relates to a through connecting piece, a power battery and a cap assembly thereof.

### BACKGROUND OF THE PRESENT DISCLOSURE

Compared with other types of batteries, lithium-ion secondary batteries have the advantages of high energy density, long cycle life, and no memory effect, therefore, the lithium-ion secondary batteries have been successfully commercialized and widely used in various portable appliances and power supplies. With changes and developments in the market, the lithium-ion secondary batteries have been in an increasingly high demand for the energy density and charge-discharge performance, for example, a high rate charge-discharge power battery is usually used in HEV applications, there will be a very high demand for the overcurrent capability of an electrode post when the battery has a relatively small thickness; meanwhile, safety problems existing in the battery become more severe due to the development tendency of the battery such as high voltage, thin battery, large capacity and the like. For example, UL1642 certification requires the power battery must pass a side crush test, a specific operation is that a side of a fully-charged battery is crushed by a force of 13KN, it is required that the battery is not on fire and is not exploded finally.

Typically, temperature rise of the battery due to overcurrent directly affects the performance and the service life of the battery, when some batteries having relatively small thickness are applied in the condition that requires high rate charge-discharge such as in the HEV application, the electrode post having a conventional circular cross-section usually produces high heat by overcurrent due to thickness limit, which seriously affects the performance of the battery;

in addition, the reason why the lithium-ion battery has a failure risk is that, a crushing process will cause electrode plates inside the battery to be disordered and broken, a cathode aluminum foil comes into contact with an anode graphite so as to cause an internal short-circuit, if the structural strength of the cap plate at the electrode post is not enough and ruptured and combustible gases inside the battery are leaked out at the electrode post, a fire is caused at high temperature circumstance, resulting in safety accident. At present, because there is not a very effective solution for the safety improvements when the battery is crushed, these safety problems become more striking and important due to the increasing energy density requirements and the increasingly wide applications on the lithium-ion battery.

### SUMMARY OF PRESENT DISCLOSURE

In view of the problem existing in the background, an object of the present disclosure is to provide a through connecting piece, a power battery and a cap assembly thereof, the through connecting piece can effectively improve the overcurrent performance of a conductor having a certain thickness.

Another object of the present disclosure is to provide a through connecting piece, a power battery and a cap assembly thereof, which can improve the structural strength and structural reliability of the through connecting piece, the power battery and the cap assembly thereof, so as to improve the safety performance of the power battery.

In order to achieve the above objects, in a first aspect, the present disclosure provides a through connecting piece, which comprises: a base having at least an opening; a conductor, the number of the conductor is the same as the number of the opening, the each conductor is provided through the corresponding one opening and a part of the each conductor received in the corresponding one opening has a shape of a racetrack or a rectangle with rounded corners in a top view; and a heat-resistant insulative material, the number of the heat-resistant insulative material is the same as the number of the opening, the each heat-resistant insulative material is filled in the opening between the corresponding one base and the corresponding one conductor.

In order to achieve the above objects, in a second aspect, the present disclosure provides a cap assembly of power battery, which comprises: a cap plate ; and the through connecting piece according to the first aspect of the present disclosure. Wherein, the cap plate and the base of the through connecting piece are integrally formed, or the cap plate and the base of the through connecting piece are connected together by welding.

In order to achieve the above objects, in a third aspect, the present disclosure provides a power battery, which comprises: the cap assembly of the power battery according to the second aspect of the present disclosure, the conductors of the through connecting piece are provided as two in number and are electrically connected to a positive electrode plate and a negative electrode plate of the power battery, respectively.

The present disclosure has the following beneficial effects:

Compared with the prior art, when the part of the each conductor received in the corresponding one opening has the shape of the racetrack or the rectangle with rounded corners in a top view, an area for the current flowing through the conductor is increased, thereby effectively improving the overcurrent performance of the conductor of the power battery having a certain thickness when is applied to a power battery, especially effectively improving the overcurrent performance of the conductor of the power battery having a relatively small thickness. Meanwhile, a force bearing area of the heat-resistant insulative material can be greatly improved when the through connecting piece is crushed and impacted by an external force, which effectively prevents rupturing and loosening of structures of the through connecting piece, the power battery and the cap assembly thereof, improves the structural strength and structural reliability of the through connecting piece, the power battery and the cap assembly thereof, avoids battery fire and other safety accidents due to leakage caused by rupturing or loosening of the structures and safety problems of the power battery due to impacting by the external force, so as to greatly improve the safety performance of the power battery.

### BRIEF DESCRIPTION OF THE FIGURES

FIG. 1 is a perspective view of an embodiment of a through connecting piece according to the present disclosure;

FIG. 2 is a top view of FIG. 1, in which an edge of the opening is shown by a dotted line;

FIG. 3 is a cross-sectional view taken along a line A-A of FIG. 2;

FIG. 4 is an alternative embodiment of FIG. 3;

FIG. 5 is an alternative embodiment of FIG. 3;

FIG. 6 is an alternative embodiment of FIG. 3;

FIG. 7 is an alternative embodiment of FIG. 3;

FIG. 8 is a perspective view of another embodiment of the through connecting piece according to the present disclosure;

FIG. 9 is a top view of FIG. 8, in which an edge of the opening is shown by a dotted line;

FIG. 10 is a perspective view of an embodiment of a cap assembly of a power battery according to the present disclosure, in which the cap plate and the base of the through connecting piece are integrally formed, and only the base of the through connecting piece is given a reference numeral;

FIG. 11 is a cross-sectional view taken along a line B-B of FIG. 10;

FIG. 12 is a perspective view of another embodiment of the cap assembly of a power battery according to the present disclosure;

FIG. 13 is a perspective view of the power battery according to the present disclosure, in which the cap plate and the base of the through connecting piece are integrally formed, and only the base of the through connecting piece is given a reference numeral;

FIG. 14 is a front view of FIG. 13, in which the through connecting piece is shown by partial cross section, and the cap plate and the base of the through connecting piece are integrally molded, and only the base of the through connecting piece is given a reference numeral.

Reference numerals of the embodiments are represented as follows:

| | |
|---|---|
| 1 through connecting piece | 123 recessed portion |
| 11 base | 124 top portion |
| 111 opening | 125 threaded hole |
| 112 groove | 13 heat-resistant insulative material |
| 113 upper edge portion | 2 cap plate |
| 114 lower edge portion | 21 vent hole |
| 12 conductor | 22 electrolyte-injection hole |
| 121 bottom portion | C cap assembly of power battery |
| 122 platform | |

### DETAILED DESCRIPTION

Hereinafter a through connecting piece, power battery and cap assembly thereof according to the present disclosure will be described in detail in combination with the figures.

Firstly, a through connecting piece according to a first aspect of the present disclosure will be described.

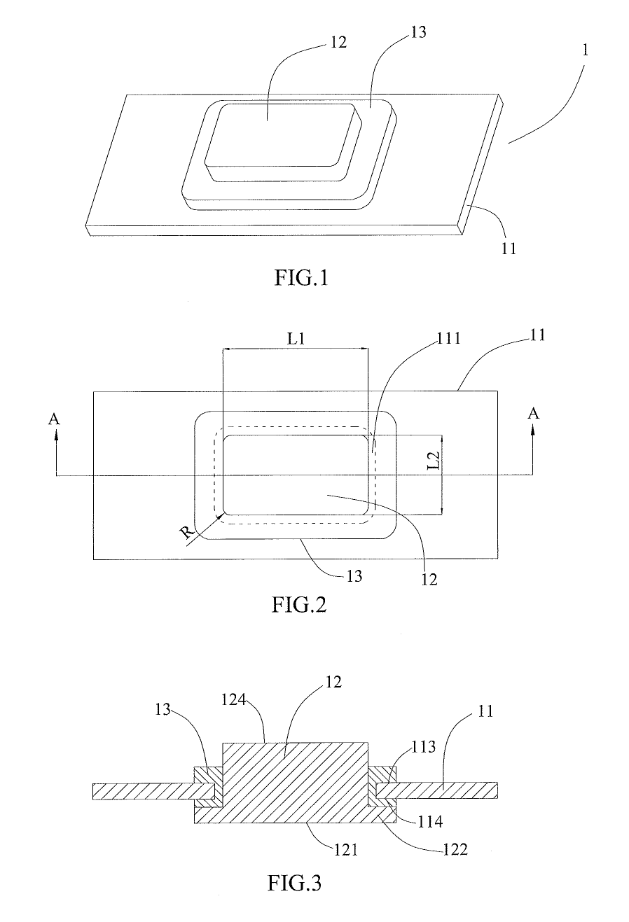

Referring to FIGS. 1-14, a through connecting piece 1 according to the present disclosure comprises: a base 11 having at least an opening 111; a conductor 12, the number of the conductor 12 is the same as the number of the opening 111, the each conductor 12 is provided through the corresponding one opening 111 and a part of the each conductor 12 received in the corresponding one opening 111 has a shape of a racetrack or a rectangle with rounded corners in a top view (referring to FIG. 2 and FIG. 9); and a heat-resistant insulative material 13, the number of the heat-resistant insulative material is the same as the number of the opening 111, the each heat-resistant insulative material 13 is filled in the opening 111 between the corresponding one base 11 and the corresponding one conductor 12.

Compared with the prior art, when the part of the each conductor 12 received in the corresponding one opening 111 has the shape of the racetrack or the rectangle with rounded corners in a top view, an area for the current flowing through the conductor 12 (referring to FIG. 2 and FIG. 9, the current conducts in a direction perpendicular to the paper surface) is increased, thereby effectively improving the overcurrent performance of the conductor 12 of the through connecting piece 1 having a certain thickness, and effectively improving the overcurrent performance of the conductor 12 of the through connecting piece 1 having a relatively small thickness when is applied to a power battery (especially a power battery with a square shell). Meanwhile, a force bearing area of the heat-resistant insulative material 13 can be greatly improved when is crushed and impacted by an external force, which effectively prevents rupturing and loosening of structures of the through connecting piece, the power battery and the cap assembly thereof as described below, improves the structural strength and structural reliability of the through connecting piece, the power battery and the cap assembly thereof as described below, avoids battery fire and other safety accidents due to leakage caused by rupturing or loosening of the structure and safety problems of the power battery due to impacting by the external force, so as to greatly improve the safety performance of the power battery.

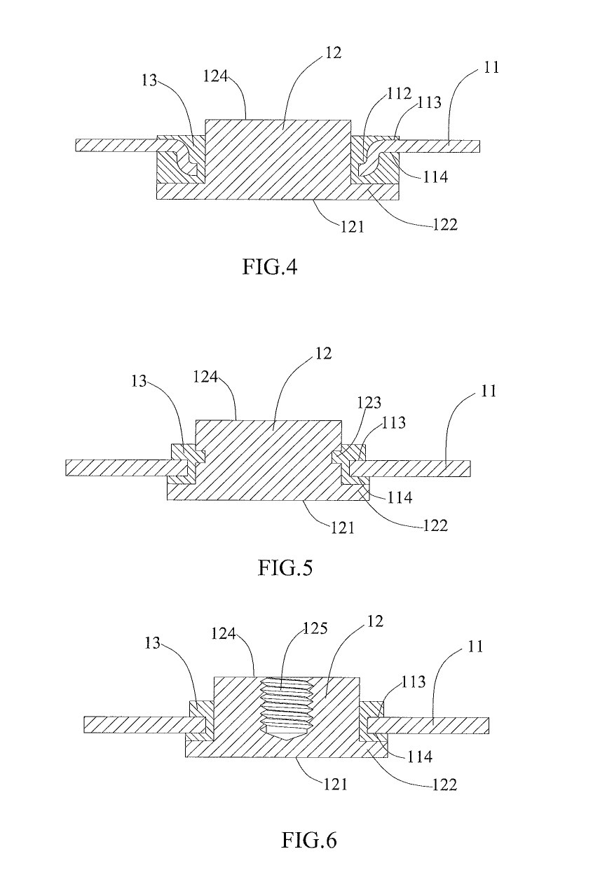

In an embodiment of the through connecting piece 1 according to the first aspect of the present disclosure, the opening 111 of the base 11 along a direction from a top surface of the base 11 to a bottom surface of the base 11 may be consistent or inconsistent. In other words, the base 11 of the through connecting piece 1 may directly form an opening on a plate (the opening 111 of the base 11 in the direction from the top surface to the bottom surface of the base 11 does not change, referring to FIG. 3, FIGS. 5-7, FIG. 11, FIG. 14), may also be punched out a special-shaped recessing structure (that is, the opening 111 of the base 11 in the direction from the top surface to the bottom surface of the base 11 changes, referring to FIG. 4).

In an embodiment of the through connecting piece 1 according to the first aspect of the present disclosure, referring to FIG. 4, FIG. 11 and FIG. 14, the base 11 may be provided with a groove 112 at the opening 111, and the heat-resistant insulative material 13 is further filled in the groove 112. There is more space to receive the heat-resistant insulative material 13 by providing the groove 112, which can greatly improve the structural strength, structural reliability and sealing effect. In an embodiment, a height of the groove 112 may be 0.5 mm˜10 mm.

In an embodiment of the through connecting piece 1 according to the first aspect of the present disclosure, the base 11 may be rectangular (referring to FIG. 1), oval, or circular in shape.

In an embodiment of the base 11, a material of the base 11 may be selected from one or more of aluminum, aluminum alloy, steel, stainless steel, magnesium and magnesium alloy.

In an embodiment of the conductor 12, referring to FIGS. 3-6, FIG. 11 and FIG. 14, an end of the conductor 12 close to a bottom portion 121 of the base 11 may be provided with a platform 122. The platform 122 is used for welding with electrode tabs of the battery. In an embodiment, the platform 122 may be rectangular, racetrack, oval, or circular in shape.

In an embodiment of the through connecting piece 1 according to the first aspect of the present disclosure, referring to FIG. 1 and FIG. 2, when the part of the conductor 12 received in the corresponding one opening 111 has the shape of the rectangle with rounded corners in a top view, a length of the rectangle with rounded corners is L1, a width is L2, and a radius of an angular rounded corner is R, and L1≧L2, 0≦R<L2/2. Here, it should be noted that, when R is equal to 0, the rectangle with rounded corners becomes a geometrical standard rectangle.

In an embodiment of the through connecting piece 1 according to the first aspect of the present disclosure, referring to FIGS. 8-14, when the part of the conductor 12 received in the corresponding one opening 111 has the shape of the racetrack in a top view, a length of the racetrack is L1, a width is L2, a radius of an angular rounded corner is R, and L1≧L2, R≧2/2, and when R is equal to L2/2, L1>L2.

In an embodiment of the through connecting piece 1 according to the first aspect of the present disclosure, referring to FIG. 5, a side of the conductor 12 opposite to the base 11 may be provided with at least a recessed portion 123 and the heat-resistant insulative material 13 is further filled in the recessed portion 123. When there is a recessed portion 123, the heat-resistant insulative material 13 may be better embedded in the conductor 12, so as to greatly improve the structural strength, structural reliability and sealing effect.

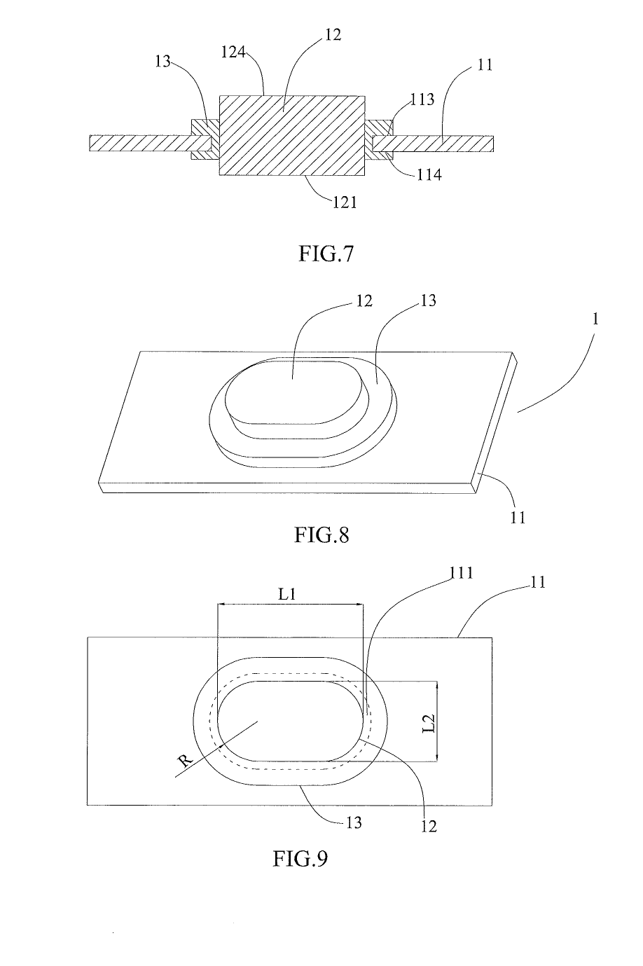

In an embodiment of the through connecting piece 1 according to the first aspect of the present disclosure, a top portion 124 of the conductor 12 may be provided with a threaded hole 125 (referring to FIG. 6). The threaded hole 125 facilitates external electrical connection for the power battery (for example, by a bolt (not shown) which is screwed).

In an embodiment of the conductor 12, a material of the conductor 12 may be selected from one or more of aluminum and aluminum alloy, copper and copper alloy, magnesium and magnesium alloy.

In an embodiment of the heat-resistant insulative material 13, the heat-resistant insulative material 13 may be glass or glass ceramic.

In an embodiment of the through connecting piece 1 according to the first aspect of the present disclosure, referring to FIGS. 3-7, FIG. 11 and FIG. 14, the each heat-resistant insulative material 13 filled in the opening 111 between the corresponding one base 11 and the corresponding one conductor 12 further covers an upper edge portion 113 and a lower edge portion 114 of the base 11 at the opening 111.

Next, a cap assembly of a power battery according to a second aspect of the present disclosure will be described.

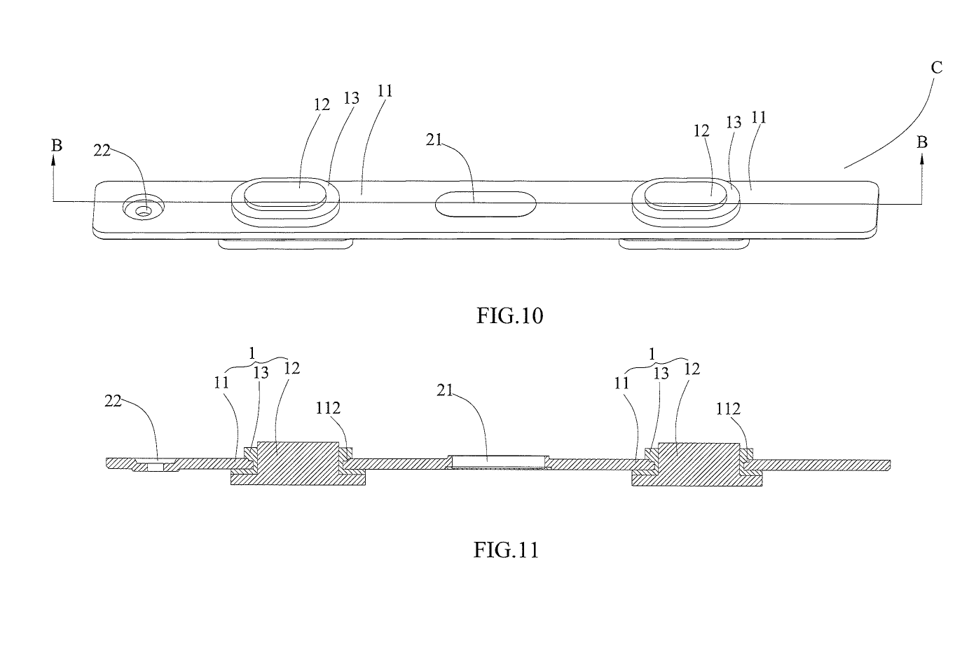

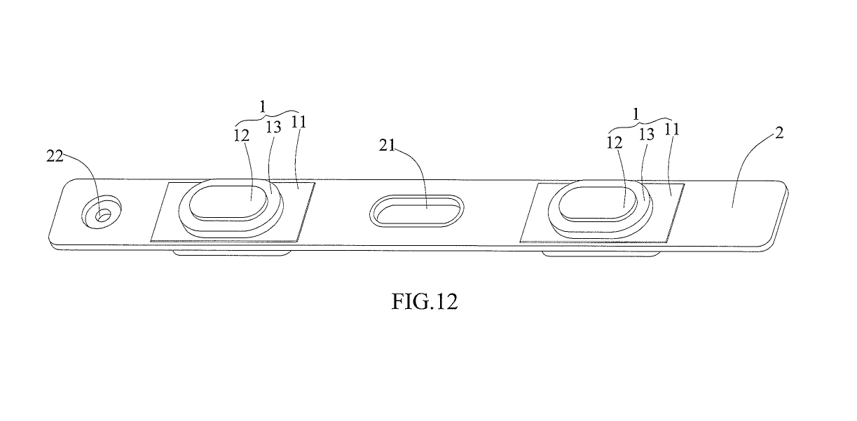

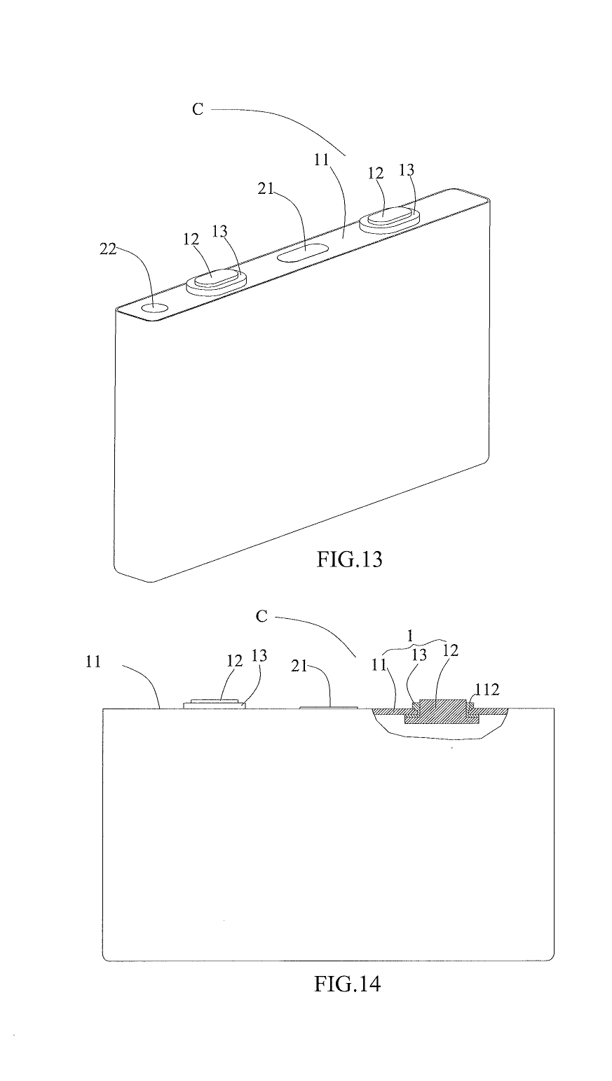

Referring to FIGS. 10-14, a cap assembly C of a power battery according to a second aspect of the present disclosure comprises: a cap plate 2; and the through connecting piece 1 according to the first aspect of the present disclosure. Wherein, the cap plate 2 and the base 11 of the through connecting piece 1 are integrally formed (referring to FIG. 10 and FIG. 11, FIG. 13 and FIG. 14), or the cap plate 2 and the base 11 of the through connecting piece 1 are sealed and connected together by welding (referring to FIG. 12).

In an embodiment of the cap plate 2, referring to FIGS. 10-14, the cap plate 2 may be provided with a vent hole 21 and an electrolyte-injection hole 22.

Next, a power battery according to a third aspect of the present disclosure will be described.

Referring to FIG. 13 and FIG. 14, a power battery of a third aspect of the present disclosure comprises: the cap assembly C of the power battery according to the second aspect of the present disclosure, the conductors 12 of the through connecting piece I are provided as two in number and are electrically connected to a positive electrode plate and a negative electrode plate (not shown) of the power battery, respectively.

In the power battery according to the third aspect of the present disclosure, the power battery may be a power battery with a square shell.

Finally, tests and test results of the power battery according to the present disclosure would be described.

In order to test the safety performance and the overcurrent performance of the power battery of the present disclosure, the power battery with a square shell 2117385 (the power battery had a thickness of 21 mm, a width of 173 mm, a height of 85 mm and a rated capacity of 18AH) was selected as an evaluation object, the evaluation method mainly included the following steps: assembling a power battery described by the present disclosure which has the structure of FIG. 13 (the part of the conductor 12 received in the corresponding one opening 111 had the shape of the racetrack in a top view, referring to FIG. 9) as an example, and assembling a power battery 2117385 (the battery had a thickness of 21 mm, a width of 173 mm, a height of 85 mm and a rated capacity of 18AH) having a through connecting conductor which had a circular cross-sectional shape as a comparative example using the same material system and process, then, selecting 50 power batteries as the examples and the comparative examples respectively, selecting the power batteries to perform an overcurrent temperature test (under 3C and 5C discharging rate) and a crush test and an impact test, counting the batteries which were failed and on fire. The test results were shown in Table 1 and Table 2. In the examples, the two conductors used for electrically connecting a positive electrode plate and a negative electrode plate of the power battery were made of aluminum and copper, respectively, in the comparative examples, the two conductors used for electrically connecting a positive electrode plate and a negative electrode plate of the power battery were made of aluminum and copper, respectively.

TABLE 1
test results of the safety performance of the power batteries
in the examples and comparative examples

| | | number of the power batteries which | |
|---|---|---|---|
| | | were on fire | |
| | number of | comparative | |
| test item | samples | examples | examples |
| crush test | 50 | 24 | 0 |
| weight impact test | 50 | 9 | 0 |

TABLE 2
overcurrent temperature test results of the power batteries
in the examples and comparative examples

| | number of the power batteries | |
|---|---|---|
| | which were on fire | |
| test item | comparative examples | examples |
| average temperature rise under | 45° C. | 12° C. |
| 3C discharging rate after 20 | | |
| minutes | | |
| average temperature rise under | 68° C. | 25° C. |
| 5C discharging rate after 12 | | |
| minutes | | |

It could be seen that from the test results in Table 1 and Table 2, compared with the prior art, the present disclosure could indeed significantly improve the overcurrent performance and the safety performance under abuse of the lithium-ion secondary battery, the present disclosure had more obvious safety advantages especially for the crush test.

What is claimed is:

1. A through connecting piece (1), comprising:
a base (11) having at least an opening (111);
a conductor (12), the number of the conductor (12) being the same as the number of the opening (111), the each conductor (12) being provided through the corresponding one opening (111) and a part of the each conductor (12) received in the corresponding one opening (111) having a shape of a racetrack or a rectangle with rounded corners in a top view; and
a heat-resistant insulative material (13), the number of the heat-resistant insulative material being the same as the number of the opening (111), the each heat-resistant insulative material (13) being filled in the opening (111) between the corresponding one base (11) and the corresponding one conductor (12).

2. The through connecting piece according to claim 1, wherein the base (11) is provided with a groove (112) at the opening (111), and the heat-resistant insulative material (13) is further filled in the groove (112).

3. The through connecting piece according to claim 1, wherein an end of the conductor (12) close to a bottom portion (121) of the base (11) is provided with a platform (122).

4. The through connecting piece according to claim 1, wherein when the part of the conductor (12) received in the corresponding one opening (111) has the shape of the rectangle with rounded corners in a top view, a length of the rectangle with rounded corners is L1, a width is L2, and a radius of an angular rounded corner is R, and L1≧L2, 0≦R<L2/2.

5. The through connecting piece according to claim 1, wherein when the part of the conductor (12) received in the corresponding one opening (111) has the shape of the racetrack in a top view, a length of the racetrack is L, a width is L2, a radius of an angular rounded corner is R, and L1≧L2, R≧L2/2, and when R is equal to L2/2, L1>L2.

6. The through connecting piece according to claim 1, wherein a side of the conductor (12) opposite to the base (11) is provided with at least a recessed portion (123) and the heat-resistant insulative material (13) is further filled in the recessed portion (123).

7. The through connecting piece according to claim 1, wherein the heat-resistant insulative material (13) is glass or glass ceramic.

8. The through connecting piece according to claim 1, wherein the each heat-resistant insulative material (13) filled in the opening (111) between the corresponding one base (11) and the corresponding one conductor (12) further covers an upper edge portion (113) and a lower edge portion (114) of the base (11) at the opening (111).

9. A cap assembly (C) of a power battery, comprising:
a cap plate (2); and
a through connecting piece (1) comprising:
a base (11) having at least an opening (111);
a conductor (12), the number of the conductor (12) being the same as the number of the opening (111), the each conductor (12) being provided through the corresponding one opening (111) and a part of the each conductor (12) received in the corresponding one opening (111) having a shape of a racetrack or a rectangle with rounded corners in a top view; and
a heat-resistant insulative material (13), the number of the heat-resistant insulative material being the same as the number of the opening (111), the each heat-resistant insulative material (13) being filled in the opening (111) between the corresponding one base (11) and the corresponding one conductor (12);
the cap plate (2) and the base (11) of the through connecting piece (1) being integrally formed, or the cap plate (2) and the base (11) of the through connecting piece (1) being connected together by welding.

10. The cap assembly (C) of the power battery according to claim 9, wherein the base (11) is provided with a groove (112) at the opening (111), and the heat-resistant insulative material (13) is further filled in the groove (112).

11. The cap assembly (C) of the power battery according to claim 9, wherein an end of the conductor (12) close to a bottom portion (121) of the base (11) is provided with a platform (122).

12. The cap assembly (C) of the power battery according to claim 9, wherein when the part of the conductor (12) received in the corresponding one opening (111) has the shape of the rectangle with rounded corners in a top view, a length of the rectangle with rounded corners is L1, a width is L2, and a radius of an angular rounded corner is R, and L1≧L2, 0≦R<L2/2.

13. The cap assembly (C) of the power battery according to claim 9, wherein when the part of the conductor (12) received in the corresponding one opening (111) has the shape of the racetrack in a top view, a length of the racetrack is L1, a width is L2, a radius of an angular rounded corner is R, and L1≧L2, R≧L2/2, and when R is equal to L2/2, L1>L2.

14. The cap assembly (C) of the power battery according to claim 9, wherein a side of the conductor (12) opposite to the base (11) is provided with at least a recessed portion (123) and the heat-resistant insulative material (13) is further filled in the recessed portion (123).

15. The cap assembly (C) of the power battery according to claim 9, wherein the heat-resistant insulative material (13) is glass or glass ceramic.

16. The cap assembly (C) of the power battery according to claim 9, wherein the each heat-resistant insulative material (13) filled in the opening (111) between the corresponding one base (11) and the corresponding one conductor (12) further covers an upper edge portion (113) and a lower edge portion (114) of the base (11) at the opening (111).

17. A power battery, comprising:
cap assembly (C) comprising
a cap plate (2); and
a through connecting piece (1) comprising:
a base (11) having at least an opening (111);
a conductor (12), the number of the conductor (12) being the same as the number of the opening (111), the each conductor (12) being provided through the corresponding one opening (111) and a part of the each conductor (12) received in the corresponding one opening (111) having a shape of a racetrack or a rectangle with rounded corners in a top view; and
a heat-resistant insulative material (13), the number of the heat-resistant insulative material being the same as the number of the opening (111), the each heat-resistant insulative material (13) being filled in the opening (111) between the corresponding one base (11) and the corresponding one conductor (12);
the cap plate (2) and the base (11) of the through connecting piece (1) being integrally formed, or the cap plate (2) and the base (11) of the through connecting piece (1) being connected together by welding;
the conductors (12) of the through connecting piece (1) being provided as two in number and being electrically connected to a positive electrode plate and a negative electrode plate of the power battery, respectively.

18. The power battery according to claim 17, wherein when the part of the conductor (12) received in the corresponding one opening (111) has the shape of the rectangle with rounded corners in a top view, a length of the rectangle with rounded corners is L1, a width is L2, and a radius of an angular rounded corner is R, and L1≧L2, 0≦R<L2/2.

19. The power battery according to claim 17, wherein when the part of the conductor (12) received in the corresponding one opening (111) has the shape of the racetrack in a top view, a length of the racetrack is L1, a width is L2, a radius of an angular rounded corner is R, and L1≧L2, R≧L2/2, and when R is equal to L2/2, L1>L2.

20. The power battery according to claim 17, wherein a side of the conductor (12) opposite to the base (11) is provided with at least a recessed portion (123) and the heat-resistant insulative material (13) is further filled in the recessed portion (123).
